(19) United States
(12) Patent Application Publication
(10) Pub. No.: US 2026/0029300 A1
(43) Pub. Date: Jan. 29, 2026

(54) WIND TUNNEL DEVICE FOR MODEL DISPLAY

(71) Applicant: Yunnan Haxing Innovation Technology Co., Ltd., Yunnan Province (CN)

(72) Inventors: Runzhe Han, Yunnan Province (CN); Yuxuan Feng, Yunnan Province (CN); Sijin Jiang, Yunnan Province (CN); Xin Gou, Yunnan Province (CN)

(21) Appl. No.: 19/008,472

(22) Filed: Jan. 2, 2025

(30) Foreign Application Priority Data
Jul. 29, 2024 (CN) 2024218055987

(51) Int. Cl. G01M 9/04

(52) U.S. Cl. CPC G01M 9/04

(57) ABSTRACT

A wind tunnel device for model display, which belongs to the technical field of wind tunnels. The wind tunnel device includes a shell. A display part for placing a model is connected to an inside of the shell. An opening is formed on the shell at a location corresponding to the display part. A movable part is connected in the opening. A fairing member is provided on a front side of the display part, and a diffusion member is provided on a rear side of the display part. A portion of the display part between the fairing member and the diffusion member is formed as a test area in the shell. An oil atomizer, a smoke exhaust pump and a fan are installed in the shell. The smoke exhaust pump is used to convey smoke generated by the oil atomizer to a front side of the fairing member.

### BACKGROUND OF THE INVENTION

### Field of the Invention

The present invention belongs to the technical field of wind tunnels, and particularly relates to a wind tunnel device for model display.

### Description of Related Art

In the related art, in order to better display a model, especially a fine automobile model, the model is usually placed in a transparent box, and a light module is added in the box to emit various gorgeous colors, so as to achieve the effect of beautifying the display.

However, this method in the related art has obvious disadvantages. First, this display method can only provide a limited dynamic display effect, and the change of light color cannot fully display dynamic lines of an automobile model, which limits the user experience and playability. Secondly, for an automobile model that requires a greater degree of dynamic display, although there is a method of using special wind tunnel devices for display, these devices are often bulky and inconvenient to carry, which limits the scope of application and convenience thereof.

Therefore, a wind tunnel device for model display is provided to solve the above problems.

### SUMMARY OF THE INVENTION

An object of the present invention is to provide a wind tunnel device for model display to solve the problem of insufficient miniaturization of wind tunnels in the related art.

In order to achieve the above object, the present invention adopts the following technical solutions.

A wind tunnel device for model display, the wind tunnel device including: a shell, in which a display part for placing a model is connected to an inside of the shell, an opening is formed on the shell at a location corresponding to the display part, a movable part for opening or closing the opening is connected in the opening, a fairing member is provided on a front side of the display part, a diffusion member is provided on a rear side of the display part, a portion of the display part between the fairing member and the diffusion member is formed as a test area in the shell,
an oil atomizer, a smoke exhaust pump and a fan are installed in the shell, the smoke exhaust pump is used to convey smoke generated by the oil atomizer to a front side of the fairing member, the fan is provided on a rear side of the diffusion member, and the fan is used to convey airflow from a front side to a rear side of the shell such that the smoke is made into uniform thin streams at the test area after passing through the fairing member.

Preferably, the movable part is a cover plate made of a transparent material.

Preferably, the opening at least covers two side walls of the shell, and the cover plate is provided with a bent surface corresponding to the opening.

Preferably, the wind tunnel device further includes a flow divider. The flow divider is vertically disposed on the front side of the fairing member. A plurality of branch tubes are disposed on a side wall of the flow divider, the branch tubes are distributed equidistantly in a vertical direction, and output ends of the branch tubes are disposed directly facing the fairing member. An input end of the flow divider is connected to an output end of the smoke exhaust pump.

Preferably, a control main board is installed inside the shell, and the control main board is electrically connected to the oil atomizer, the smoke exhaust pump and the fan. A control button and a display screen are installed on an outer wall of the shell. The control button is electrically connected to the control main board to control on and off of a power supply, and the display screen is electrically connected to the control main board to display parameter information of the control main board.

Preferably, the shell is provided in a front-rear through manner, a hollowed-out plate is installed at a front end of the shell, and an exhaust passage is provided at a rear end of the shell.

Preferably, an illumination module is installed inside the shell, and the illumination module is located in the test area.

In summary, the present invention has the following technical effects and advantages. The design of a desktop wind tunnel combines advanced atomization technology and reasonable wind tunnel structure to ensure the accuracy and repeatability of the test. The wind tunnel is not only suitable for scientific research and teaching, but also particularly suitable for personal inspection of the aerodynamic performance of automobile models, and provides a precise and reliable testing platform for model car enthusiasts.

### BRIEF DESCRIPTION OF THE DRAWINGS

FIG. 1 is a schematic diagram of an external structure of the present invention.

FIG. 2 is a schematic diagram of an internal structure of the present invention.

FIG. 3 is a schematic diagram of a use state of the present invention.

### REFERENCE SIGNS LIST

1: shell, 2: display part, 3: movable part, 4: fairing member, 5: diffusion member, 6: test area, 7: oil atomizer, 8: smoke exhaust pump, 9: fan, 10: flow divider, 11: control main board, 12: control button, 13: display screen, 14: hollowed-out plate, 15: exhaust passage, 16: illumination module

### DETAILED DESCRIPTION OF THE INVENTION

The technical solutions in the embodiments of the present invention will be clearly and completely described below with reference to the accompanying drawings in the embodiments of the present invention. Obviously, the described embodiments are merely some, not all, of the embodiments of the present invention.

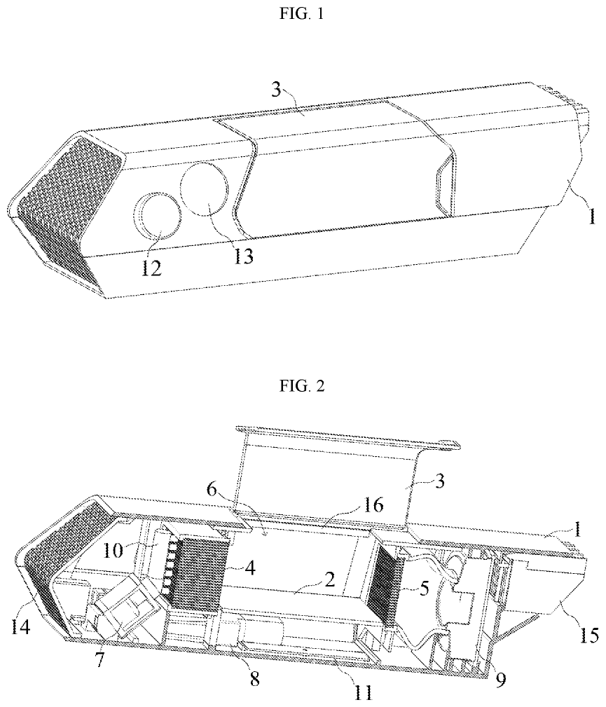

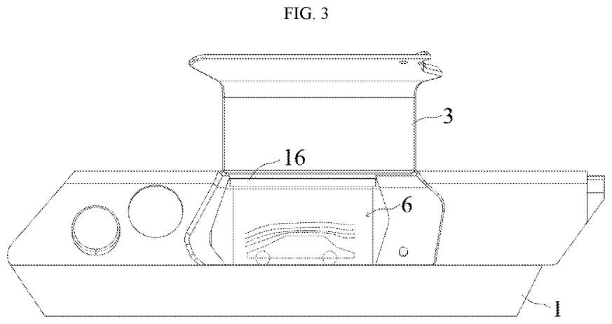

As shown in FIGS. 1 to 3, a wind tunnel device for model display includes a shell 1, and a display part 2 for placing a model is connected to an inside of the shell 1. Specifically, the display part 2 is a plate-shaped structure and is fixedly connected to an inner side wall of the shell 1 to play the role of supporting models. An opening is formed on the shell 1 at a location corresponding to the display part 2, and a movable part 3 for opening or closing the opening is connected in the opening. The movable part 3 is a cover plate made of a transparent material, such as glass or acrylic plate. In this way, when the cover plate is closed, the interior of the shell 1 can still be observed, which is convenient for observing and recording flow field phenomena.

Further, the opening at least covers two side walls of the shell 1, and the cover plate is provided with a bent surface corresponding to the opening.

In one embodiment, openings are formed on side walls of front and top surfaces of the shell 1, and the cover plate is provided as an L-shaped structure. Thus, the interior of the shell 1 can be observed from the front surface and the top surface.

In another embodiment, openings are formed on side walls of front, top and back surfaces of the shell 1, and the cover plate is provided as a U-shaped structure. Thus, the interior of the shell 1 can be observed from multiple directions.

A fairing member 4 is provided on a front side of the display part 2, and a diffusion member 5 is provided on a rear side of the display part 2. A portion of the display part 2 between the fairing member 4 and the diffusion member 5 is formed as a test area 6 in the shell 1. When in use, an automobile model is placed in the test area 6 for display or testing.

Specifically, the main purpose of the fairing member 4 is to homogenize airflow that enters the wind tunnel and reduce turbulence and instability. The uneven airflow is dispersed into uniform thin streams by installing a honeycomb structure and a fine mesh. After the airflow passes through the fairing member 4, the turbulence intensity decreases and the flow becomes more stable.

The main purpose of the diffusion member 5 is to diffuse the airflow in the test area smoothly, reduce the flow rate, and reduce the disturbance to an outlet of the wind tunnel. The diffusion member 5 shortens a passage length and gradually expands, thereby reducing the flow rate and kinetic energy of the airflow and ensuring smooth diffusion of the airflow.

From a structural point of view, with reference to FIG. 2, the fairing member 4 includes a plurality of long tubes disposed side by side. After the airflow enters, the plurality of long tubes disperse the airflow to form thin streams. The diffusion member 5 includes a plurality of short tubes disposed side by side. After the airflow passes through the short tubes, the airflow immediately enters a larger space, which reduces the flow rate of the airflow and makes the airflow diffuse smoothly. At the same time, positions of the long tubes and the short tubes are one-to-one corresponding, thereby ensuring that the airflow maintains a constant cross-sectional shape in the test area 6 between the fairing member 4 and the diffusion member 5, reducing the influence of boundary layers and ensuring the uniformity of a flow field.

Further, an oil atomizer 7, a smoke exhaust pump 8 and a fan 9 are installed in the shell 1. The oil atomizer 7 refers to an electric heating oil-based liquid atomizer, which is used to generate visible smoke. The principle thereof is to use an electric heating element to heat an oil-based liquid to an atomization temperature, and thus the liquid evaporates rapidly and forms fine smoke particles through a nozzle. The process of smoke generation is as follows. The electric heating element rapidly heats the oil-based liquid to the boiling point thereof, and the liquid turns into steam. The high-temperature steam is ejected at high speed through a fine nozzle and is instantly cooled to form fine smoke particles. At the same time, the oil atomizer 7 is also provided with a temperature controller and a switch to ensure that the heating process is safe and stable, so that the oil atomizer 7 can work continuously or intermittently.

The smoke exhaust pump 8 is used to convey the smoke generated by the oil atomizer 7 to a front side of the fairing member 4. The specific working principle is as follows. The smoke exhaust pump 8 suctions the smoke out of the oil atomizer 7 through negative pressure, and a motor in the smoke exhaust pump 8 drives an impeller or piston to convey the smoke to the test area 6 of the wind tunnel at a constant flow rate and pressure. At the same time, the smoke exhaust pump 8 is also provided with a flow regulator and a pressure sensor to ensure the stability of the flow and pressure during the conveying process and to avoid the loss of smoke or uneven concentration during the conveying process.

The fan 9 is provided on a rear side of the diffusion member 5. The fan 9 is used to convey the airflow from a front side to a rear side of the shell 1 such that the smoke is made into uniform thin streams at the test area 6 after passing through the fairing member 4. The function of the fan 9 is to drive the air in the wind tunnel to flow to form a controllable airflow environment. The specific working process is as follows. The fan 9 drives the air to flow through high-speed rotating blades, thereby forming stable airflow. By adjusting a speed of the fan 9, a speed of the airflow in the wind tunnel can be controlled to meet different test requirements. At the same time, the fan 9 is designed to be streamlined, which can effectively reduce the turbulence and instability in the airflow and ensure the uniformity and stability of the airflow in the wind tunnel.

That is, after the oil atomizer 7 atomizes an oil, the smoke exhaust pump 8 draws out the smoke, and the fan 9 works at the rear side to generate suction. Thus, the smoke passes through the test area 6 uniformly and acts on a surface of an automobile model, thereby implementing a wind tunnel test, which can play a role in testing or display.

In order to further implement the guiding of the smoke, the wind tunnel device further includes a flow divider 10. The flow divider 10 is vertically disposed on the front side of the fairing member 4. A plurality of branch tubes are disposed on a side wall of the flow divider 10, the branch tubes are distributed equidistantly in a vertical direction, and output ends of the branch tubes are disposed directly facing the fairing member 4. An input end of the flow divider 10 is connected to an output end of the smoke exhaust pump 8. This allows the smoke to be output from a plurality of outlets in the vertical direction, making the concentration and flow rate of the smoke more uniform.

The shell 1 is provided in a front-rear through manner, a hollowed-out plate 14 is installed at a front end of the shell 1, and an exhaust passage 15 is provided at a rear end of the shell 1. Thus, the air can flow naturally in the shell 1, and the operation resistance of the fan 9 is reduced.

A control main board 11 is installed inside the shell 1, and the control main board 11 is electrically connected to the oil atomizer 7, the smoke exhaust pump 8 and the fan 9. A control button 12 and a display screen 13 are installed on an outer wall of the shell 1. The control button 12 is electrically connected to the control main board 11 to control on and off of a power supply, and the display screen 13 is electrically connected to the control main board 11 to display parameter information of the control main board 11, such as power-on status, operation parameters of various electrical components, etc.

An illumination module 16 is installed inside the shell 1 and is located in the test area 6. The light generated by the illumination module 16 is applied to a model to make the smoke more obvious, thereby improving the viewing experience.

The above description is merely a preferred specific embodiment of the present invention, and the protection scope of the present invention is not limited thereto. Within the technical scope disclosed by the present invention, any equivalent substitution or change made by a person skilled in the art based on the technical solutions of the present invention and the concept thereof should be included in the protection scope of the present invention.

What is claimed is:

1. A wind tunnel device for model display, the wind tunnel device comprising: a shell (1), wherein a display part (2) for placing a model is connected to an inside of the shell (1), an opening is formed on the shell (1) at a location corresponding to the display part (2), a movable part (3) for opening or closing the opening is connected in the opening, a fairing member (4) is provided on a front side of the display part (2), a diffusion member (5) is provided on a rear side of the display part (2), a portion of the display part (2) between the fairing member (4) and the diffusion member (5) is formed as a test area (6) in the shell (1),
an oil atomizer (7), a smoke exhaust pump (8) and a fan (9) are installed in the shell (1), the smoke exhaust pump (8) is used to convey smoke generated by the oil atomizer (7) to a front side of the fairing member (4), the fan (9) is provided on a rear side of the diffusion member (5), and the fan (9) is used to convey airflow from a front side to a rear side of the shell (1) such that the smoke is made into uniform thin streams at the test area (6) after passing through the fairing member (4).

2. The wind tunnel device for model display according to claim 1, wherein the movable part (3) is a cover plate made of a transparent material.

3. The wind tunnel device for model display according to claim 2, wherein the opening at least covers two side walls of the shell (1), and the cover plate is provided with a bent surface corresponding to the opening.

4. The wind tunnel device for model display according to claim 1, further comprising: a flow divider (10), wherein the flow divider (10) is vertically disposed on the front side of the fairing member (4), a plurality of branch tubes are disposed on a side wall of the flow divider (10), the branch tubes are distributed equidistantly in a vertical direction, output ends of the branch tubes are disposed directly facing the fairing member (4), and an input end of the flow divider (10) is connected to an output end of the smoke exhaust pump (8).

5. The wind tunnel device for model display according to claim 1, wherein a control mainboard (11) is installed inside the shell (1), the control mainboard (11) is electrically connected to the oil atomizer (7), the smoke exhaust pump (8) and the fan (9), a control button (12) and a display screen (13) are installed on an outer wall of the shell (1), the control button (12) is electrically connected to the control mainboard (11) to control on and off of a power supply, and the display screen (13) is electrically connected to the control mainboard (11) to display parameter information of the control mainboard (11).

6. The wind tunnel device for model display according to claim 1, wherein the shell (1) is provided in a front-rear through manner, a hollowed-out plate (14) is installed at a front end of the shell (1), and an exhaust passage (15) is provided at a rear end of the shell (1).

7. The wind tunnel device for model display according to claim 1, wherein an illumination module (16) is installed inside the shell (1), and the illumination module (16) is located in the test area (6).

8. The wind tunnel device for model display according to claim 2, wherein an illumination module (16) is installed inside the shell (1), and the illumination module (16) is located in the test area (6).

9. The wind tunnel device for model display according to claim 3, wherein an illumination module (16) is installed inside the shell (1), and the illumination module (16) is located in the test area (6).

10. The wind tunnel device for model display according to claim 4, wherein an illumination module (16) is installed inside the shell (1), and the illumination module (16) is located in the test area (6).

11. The wind tunnel device for model display according to claim 5, wherein an illumination module (16) is installed inside the shell (1), and the illumination module (16) is located in the test area (6).

12. The wind tunnel device for model display according to claim 6, wherein an illumination module (16) is installed inside the shell (1), and the illumination module (16) is located in the test area (6).
